(19) United States
(12) Patent Application Publication
(10) Pub. No.: US 2007/0055938 A1
(43) Pub. Date: Mar. 8, 2007

(54) Server-based method for providing internet content to users with disabilities

(75) Inventors: Richard D. Herring, Edison, NJ (US); Paul R. Michaelis, Louisville, CO (US)

Correspondence Address: COHEN, PONTANI, LIEBERMAN & PAVANE, 551 FIFTH AVENUE, SUITE 1210, NEW YORK, NY, 10176, US

(73) Assignee: Avaya Technology Corp.

(21) Appl. No.: 11/221,120

(22) Filed: Sep. 7, 2005

(51) Int. Cl. G06F 15/16; G06F 3/00

(52) U.S. Cl. 715/729; 709/217

(57) ABSTRACT

A server-oriented method and system for providing access to Internet resources. A web server is used to convert the content of web pages in a plurality of formats compatible with users' devices or with the needs of users with disabilities and to provide the users with the requested web pages in the format compatible with their specific needs or with the requirements/capabilities of the user device.

### BACKGROUND OF THE INVENTION

1. Field of the Invention

The present invention relates to the field of communication networks. More particularly, the present invention pertains to methods for providing access to Internet resources for users with disabilities and for transforming requested content from the Internet into a format suitable for a user's receiving device.

2. Description of the Related Art

Within the prior art, there are examples of on-line documents and web pages in which users may customize the appearance of the page in order to accommodate a specific disability, without requiring specialized assistive adjuncts to be present on the end-user's device. For example, certain web pages allow users to specify the font (Verdana, Arial, Georgia, Geneva, Times, or Courier) and a font size between 10 and 20 points. Within the context of this application, it is important to note that accommodations such as these are of value chiefly to people with mild-to-moderate vision loss, and are of no value to people who, for example, cannot see a screen or be expected to operate point-and-click devices such as a mouse.

For this reason, during the last decade, a number of national and international guidelines have been developed to make documents and Internet resources accessible to users with disabilities, such as blindness, extreme-low vision, mobility impairments, speech impairments, and hearing impairments. An illustrative example of these accessibility guidelines are the regulations of the Architectural and Transportation Barriers Compliance Board (36 CFR Part 1194), which implement Section 508 of the Rehabilitation Act (29 USC 794d), as amended by PL. No. 106-246 (Jul. 13, 2000). Common to these guidelines is the assumption that the devices employed by users with disabilities in order to access the Internet (illustratively, a personal computer) will be equipped with specialized support in a form of assistive software or hardware, the purpose of which is to convert the content of web pages into a format compatible with the users' needs. For example, to accommodate the needs of blind users and users with extreme-low vision, the guidelines call for graphical images to include underlying text tags that allow assistive text-to-speech software to provide verbal description of the images. Similarly, for the benefit of people who cannot operate point-and-click devices such as a mouse, the guidelines recommend that all functions be accessible from a keyboard.

Presently, specialized support for users with moderate to severe disabilities is available only when the appropriate assistive adjunct has been installed on their computers. (Examples of assistive software commonly used by people who are blind include the Java Access with Speech (JAWS)™ adjunct produced by Freedom Scientific Corporation and the Window-Eyes™ produced by GW Micro.)

An obvious drawback to the reliance on end-point based assistive adjuncts is the expense. It is not unusual for individual installations of assistive hardware or software to cost well in excess of one thousand dollars. For this reason, even though the fortunate person with disabilities may have the appropriate adjuncts on the equipment they use in their home or office, it is unlikely that other Internet access points available to the general public (e.g., the computers terminals in a library, etc.) will be operable by them.

A less obvious problem is that the marketplace is seeing more and more browser-equipped devices that cannot be used in conjunction with traditional assistive adjuncts. Common reasons for the incompatibility include limitations in the devices' display (size and resolution), processor speed, and memory. Illustrative examples of browser-equipped devices that cannot be used in conjunction with JAWS or Window-Eyes include the Avaya Models 4620 and 4630 IP telephones. When one takes into account that there is an increasing desire on the part of manufacturers and service providers to supply documentation, such as product user guides, via the Internet—and when one also takes into account that the FCC requires manufacturers and services providers to offer such documentation in alternative formats that would be accessible to people with disabilities (Code of Federal Regulations, Part 36 CFR 1193.33a)—it becomes apparent that the solutions of the prior art are inadequate.

Therefore, there is a need for an improved method for providing access to Internet resources for users with disabilities. There is also a need to transform requested Internet content to a format compatible with a user's terminal device.

### SUMMARY OF THE INVENTION

Various deficiencies of the prior art are addressed by the present invention of a server-oriented method for providing access to Internet resources for users with disabilities (e.g., blindness, extreme-low vision, mobility impairments, and hearing impairments, among other disabilities) as well as access to Internet resources when browsers of limited capabilities are employed (e.g., limited screen size and resolution, limited processor speed, limited memory, and so on). Another aspect of the invention is a system implementing the inventive method.

In one embodiment, the conversion of web content into a preferred format is done by assistive processes that reside on or are otherwise accessible by the web server rather than by adjuncts that reside on the client system. Specifically, although it has typically been the case that specialized client-based assistive adjuncts are employed in order to convert web content into formats that are accessible to people with disabilities, this method places the responsibility for transformations upon the server and resources it controls. The method uses the server to dynamically convert the content of web pages associated with the requested Internet resources into a plurality of formats compatible with the needs of users with disabilities and provides each user with the requested web pages in a format matching the user's specific needs.

In one embodiment, to facilitate for fast access of the requested web pages to users with disabilities, the server maintains a single version of the pages in a format compatible with a plurality of content re-formatting (i.e., assistive) software packages stored on the server. This single version is a source document that the method transforms using processes that reside on the server. The processes take into account the user's disability-related needs. Alternatively, or in addition to the user's needs, the processes may also take into account the resources and limitations of the client system, in order to optimize the manner in which the web pages are presented.

Alternatively, the server will provide a query to the user. Based on the user's answer, (e.g., requesting a speech version of the content, for example,) the server will reformat the content into an appropriate format. As a further modification, a login procedure can be used wherein, upon a user login, a user's stored profile will be accessed and will alert the server as to the user's desired format for the requested content. For example, the profile may identify the user as someone who is blind. This will cause the server to provide the requested content as a speech file, a Braille file, etc.

In one embodiment, the server can activate specialized resources (other than the default mechanism) in order to interpret responses from users who have special needs. Thus, the server will receive a user request for information and will convert the request to a format that the server can understand. Alternatively, the server can be equipped with software so that it is capable of understanding queries in different formats. The server determines a user interface compatible with the user's disabilities and evaluates the user's communication device capabilities for presenting the content of requested web pages. The server may also activate server-based automatic speech recognition resources that allow the user to enter inputs by voice in addition to other methods of interpreting information.

Illustratively, it is reasonable to assume that a person who requires text-to-speech conversion of a document might be unable to operate a visually-oriented point-and-click input device such as a mouse; therefore, when text-to-speech conversion is requested, the server could activate server-based automatic speech recognition resources that allow the person to enter inputs by voice. For example, if a “blind format” of a document is requested, the server will assume that the user is blind and will enable appropriate resources to allow the user to access and navigate within the requested document. (With regard to why it might not make sense to enable speech recognition for all users, it is important to note that server-based speech recognition interfaces require considerably more computational resources and network bandwidth than is needed by traditional point-and-click input mechanisms. For this reason, in many cases, enablement of server-based automatic speech recognition will be justifiable only for users who are unable to operate point-and-click devices.)

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

The teachings of the present invention will become apparent by considering the following detailed description in conjunction with the accompanying drawings, in which:

FIG. 1 depicts a flow diagram of a method for providing access to Internet resources for users with disabilities and/or with user device capabilities in accordance with one embodiment of the present invention; and

FIG. 2 depicts a high-level schematic diagram of a system using the method of FIG. 1 in accordance with one embodiment of the present invention.

The appended drawings illustrate exemplary embodiments of the invention and, as such, should not be considered limiting the scope of the invention that may admit to other equally effective embodiments.

### DETAILED DESCRIPTION OF THE PRESENTLY PREFERRED EMBODIMENT

The present invention advantageously provides a server-oriented method for accessing Internet resources by users with disabilities and/or transforming requested Internet content to the requirements of the user's terminal device, e.g., computer, PDA, IP phone, etc. The inventive method facilitates accessibility of the content of web pages in formats which match specific needs of the individual users or the user's terminal devices.

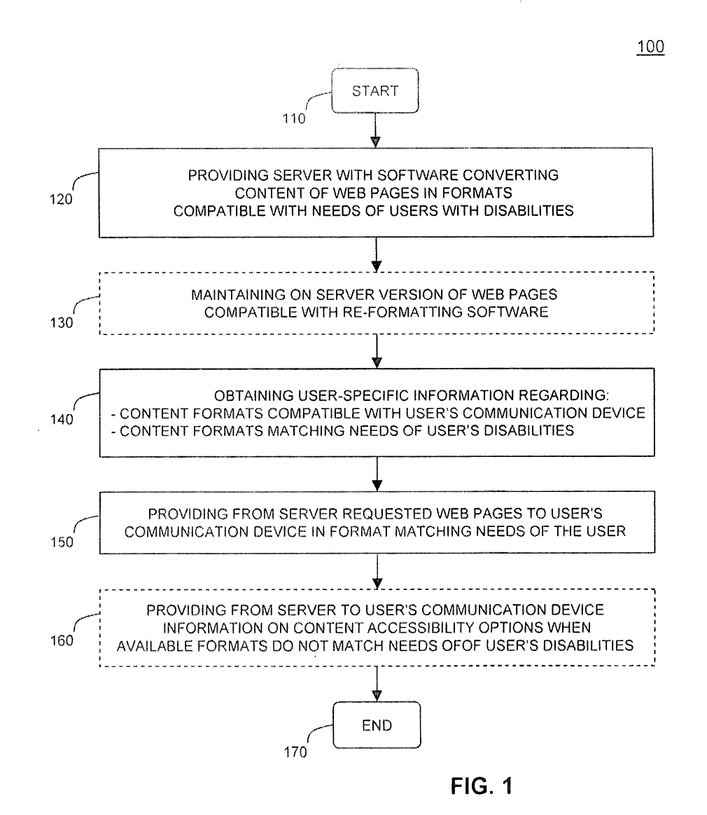

FIG. 1 depicts a flow diagram of a method 100 for providing access to Internet resources for users with disabilities (referred to hereafter as “users”) in accordance with one embodiment of the present invention. The method 100 includes processing steps performed to provide the users with requested web pages in the formats matching their specific needs or the needs of their terminal devices.

The method 100 starts at step 110 and proceeds to step 120. At step 120, a document web server (referred to hereafter as “server”) accessible by the user's terminal communication device, e.g., a computer, IP phone, etc., is provided with assistive software (or assistive software package(s)) adapted for converting the content of web pages in a plurality of formats compatible with the needs of the users or the user device. Such needs may require accommodation of disabilities such as blindness, extreme-low vision, mobility impairments, and hearing impairments, as well as other disabilities. Illustratively, for the benefit of users who are blind, text-based source documents could be converted by the server into streaming speech. Accordingly, a wider variety of users with disabilities will be able to use any Internet-compatible terminal to access information on the server (e.g., a general-purpose computer, a mobile/hand-held computer, browser-equipped telephone, and the like), regardless of whether the terminal is equipped with specialized assistive adjuncts.

In one embodiment, the server-based assistive software utilizes one or more transcoding technologies to re-format the content of web pages into a linear text format, a large-print format, a text-to-speech format or other formats compatible with the users' computing environment, which include the user's terminal device and/or specialized input/output peripheral devices used by the user. Such peripheral devices may comprise, e.g., a Braille printer, a refreshable Braille display, a text-to-speech converter, a hearing aid device, and the like. The objective of this embodiment is to ensure that specialized resources that do exist on the user's terminal are used advantageously.

At optional step 130, the server maintains a single version of the web pages that is compatible with the assistive software discussed at step 120. Availability of such version of the web pages accelerates the server's response to the requests from users requiring different forms of assistance (i.e., users accessing the content of web pages in different formats) and devices requiring different formats. Step 130 offers an efficient solution to the task of assisting the users having disabilities of different nature, as well as eliminates the need for storing on the server multiple re-formatted versions of the same web pages, each such version corresponding to a certain type of the user's request or user's device requirements. The requested web pages should be compatible with the assistive software stored on the server, but are not necessarily available for direct access by the user.

At step 140, the server obtains user-specific information about the format in which Internet resources may be accessed by the user and determines the closest match for the data stream that will accommodate the needs of the user or the user device. Such information may be relayed to the server from a variety of sources.

For example, techniques are known in the art, such as those disclosed in pending U.S. patent application Ser. No. 10/882,975 in the name of Avaya, Inc. filed on Jun. 30, 2004 and titled “Automatic Configuration of Call Handling Based on End-User Needs and Characteristics” the contents of which are incorporated by reference, which can identify a make/model number of a user device used to access Internet content. With knowledge of the make/model number, the output capabilities of the device can be ascertained, i.e. black/white display, color display, size of display, availability of output speaker, peripheral devices, etc. With this information, the requested content can be transformed by the server, if necessary, to accommodate the specific user device. The transformed content can then be output in a format that can be perceived by the user, e.g., as an audio signal, a text signal, with the text signal having a specific font, size, brightness level, etc.

In one embodiment, information relating to the nature of a user's disability may be contained in the user's request for access to Internet resources, i.e., generated by the user's computer. For example, the information may be relayed to the server through the use of an extension appended to the document's Uniform Resource Locator (URL). When the user's terminal is compatible with the Session Initiation Protocol (SIP), the information can also be provided to the server automatically, using the SIP handshake procedure.

In another embodiment, information relating to the nature of a user's disability may be obtained from the server's query, or cookie, for determining if the user's computing environment includes assistive software and/or peripheral devices commonly used for accommodating the needs of users having certain disabilities. The cookie may be stored on the user's computer and communicated to the server on status and changes in the user's computing environment and the user's preferences with respect to the means for accessing the Internet and Internet resources.

The user's assistive software may include versions of text-to-speech software, text-to-Braille software, and the like. Indicative peripheral devices are devices such as a Braille printer, a refreshable Braille display, a text-to-speech converter, a hearing aid device, and the like.

In an alternate embodiment, information relating to the nature of a user's disability may be derived from the server's user database (local database), from the database of the Internet service provider servicing the user's account (remote database), and other similar sources.

In yet another alternate embodiment, information relating to the nature of a user's disability may be derived from an interactive dialog between the server and the user. The dialog may be initiated by the server to resolve which communication formats are accessible by the user. In a preferred embodiment, to customize the format of the content of requested web pages, the server is able to query the user's computer to detect the presence of assistive software or indicative input/output devices (e.g., a Braille printer, and the like).

Additionally, the server can activate specialized resources (other than the default mechanism) in order to interpret responses from users having special needs. Thus, the server will receive a user request for information and will convert the request to a format that the server can understand. Alternatively, the server may be equipped with software capable of understanding queries in different formats.

At step 150, the server determines user interface compatible with the user's disabilities and evaluates the user's communication device capabilities for presenting the content of requested web pages. For example, the server may activate server-based automatic speech recognition resources that allow the user to enter inputs by voice in addition to other methods of interpreting information.

The server responds to the user's request for access to Internet resources by providing the content of the web pages associated with the requested Internet resources in a format best matching the needs of that user and the user communication device which, at preceding step 140, were determined using at least one of the discussed above embodiments. The particular data stream may be originated using pre-stored alternative formats of the requested information resource or using the means discussed above in reference to step 130. Alternatively, such data stream may be originated by dynamically transforming (e.g., transcoding) the requested resource into the format accessible by the user.

In one embodiment, the server dynamically re-formats the single version of web pages compatible with the assistive software present on the server into the format matching the user's needs. It should be appreciated, however, that in some instances the single format will already match the user's needs and can be simply transmitted in its existing form.

In other embodiments, content of the web pages may be re-formatted in a linear text format, a text-to-speech format, a format compatible with Braille-based peripheral devices, a large-print format, and other assistive formats. For instance, a blind user could receive visual information in an audible format or as data driving a refreshable Braille display, a user with low vision could receive such information in the large-print format, and a user with hearing disability could receive a captioned text version of the information.

Additionally, the content of transmitted web pages may be modified to address the nature of user's disabilities. For example, for a blind or color-blind user, references to colors of control members in manuals and similar documents may be replaced with references to form factors of the respective components.

At optional step 160, when none of the formats discussed above in reference to step 130 is compatible with the user's communication device (e.g., computer or IP telephone) or the user's needs, the server provides to the user's communication device information on possible content accessibility options. Such options may generally include, e.g., a list of sources of upgrades for drivers of presently installed user's peripheral devices, a list of newer user/server compatible peripheral devices, a list of user/server compatible software/hardware upgrades for the user's communication device, and the like.

At step 170, upon completion of step 160, the method 100 ends.

The present invention is particularly well-suited for providing different versions of content on non-interactive web pages, with the different versions being transformed to user's particular needs. For example, the non-interactive web pages may contain user manuals for equipment, appliances, and the like, which are typically presented in a read-only format. Storing a version of the manuals in an easily convertible or reconfigurable format, e.g., a “generic” version, and with knowledge of a user's needs, or the requirements or limitations of the user's device, the generic version can be easily reconfigured to a format which the user can perceive. The reconfigured version can then be transmitted to the user device. Thus, the need for special software such as JAWS or Window-Eyes, is no longer required on the user device.

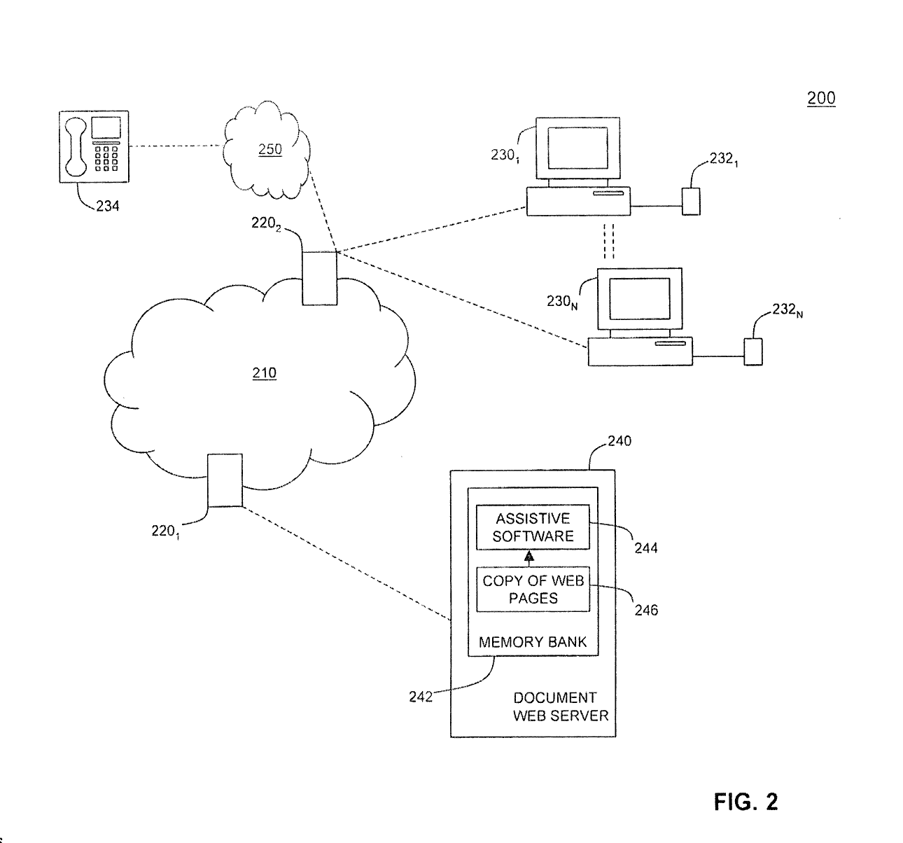

FIG. 2 depicts a high-level schematic diagram of a system 200 for performing the method of FIG. 1. The system 200 illustratively comprises a computer network such as the Internet 210 having a plurality of gateway nodes 220 (nodes 220₁ and 220₂ are shown). Arbitrarily, the gateway node 220₁ is coupled to at least one document server 240 (one document server is shown), and the gateway node 220₂ is coupled to a plurality of computer terminals 230 (terminals 230₁-230_{N} are shown, where N is an integer, and N≧1), which are accessible by the users.

Each of the computer terminals 230 may be coupled to one or more assistive peripheral devices 232, as discussed above in reference to FIG. 1. In a further embodiment, a plurality of communication devices 234 may also be coupled to the gateway node 220₁ via a PSTN or WAN 250 (one device 234 is shown).

In one embodiment, the server 240 comprises a memory bank 242 including a portion 244 containing assistive software (e.g., JAWS™, Window-Eyes™, and the like) and a portion 246 containing a single version of the web pages in a format compatible with the assistive software. Availability of such version accelerates the server's response to the requests from users requiring different forms of assistance, as discussed above in reference to step 130 in FIG. 1. The memory bank 242 may be implemented, e.g., in a form of a dedicated or shared storage device, such as a magnetic or optical hard drive, and the like.

Thus, while there have been shown and described and pointed out fundamental novel features of the present invention as applied to preferred embodiments thereof, it will be understood that various omissions and substitutions and changes in the form and details of the devices described and illustrated, and in their operation, and of the methods described may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto.

What is claimed is:

1. A method for transforming requested Internet resources to a format compatible with a user communication device or a user's disabilities, comprising:
(a) providing a document web server accessible by the user's communication device and having assistive software adapted for converting the content of web pages in a plurality of formats;
(b) obtaining user-specific information about formats compatible with the user's communication device and the user's disabilities; and
(c) selectively providing from the server to the user's communication device the content of web pages associated with the requested Internet resources in a format compatible with the user's communication device and/or matching the needs of the user's disabilities.

2. The method of claim 1, further comprising the step of (d) providing from the server to the user's communication device information on content accessibility options when the plurality of formats of step (a) does not include the format of step (c).

3. The method of claim 1, wherein the step (a) further comprises:
maintaining on the server a version of the web pages associated with Internet resources in a format compatible with said assistive software.

4. The method of claim 1, wherein the step (a) comprises:
converting the content of the web pages using at least one transcoding technology.

5. The method of claim 1, wherein the step (a) comprises: converting the content of web pages into formats consistent with users' disability-related needs, for presentation by Internet-enabled terminals that are not themselves equipped with specialized assistive adjuncts.

6. The method of claim 1 wherein the step (a) comprises:
converting the content of web pages in the formats compatible with peripheral devices assisting the users with disabilities, said disabilities selected from the group consisting of blindness, extreme-low vision, mobility impairments, and hearing impairments.

7. The method of claim 6, wherein the peripheral devices include at least one of a refreshable Braille display, a text-to-speech converter, a Braille printer, and a hearing aid device.

8. The method of claim 1 wherein the step (b) comprises:
obtaining the user-specific information from at least one source selected from the group consisting of:
a user's request for access to the Internet resources;
a server's query determining if user's computing environment includes software and/or peripheral devices intended for assisting the users with disabilities;
a user profile data available to the server from a local or remote database;
an interactive dialog between the server and the user; and
an identification of a make or model of the user's device.

9. The method of claim 8, wherein said software includes at least one of text-to-speech software and text-to-Braille software.

10. The method of claim 1, wherein the step (c) comprises: determining a user interface compatible with the user's disabilities; and evaluating the user's communication device capabilities for presenting the content of web pages.

11. The method of claim 10, further comprising: selecting the format facilitating the best match for capabilities of the user's communication device and the needs of the user's disabilities.

12. The method of claim 1, further comprising the step of estimating the user's disabilities based on the nature of the requested Internet resources and enabling functionality at the server for the user to interact with at least one of the requested content and the server.

13. The method of claim 1, wherein the step (c) comprises:
reformatting the content of the web pages into a linear text format.

14. The method of claim 1, wherein the step (c) comprises:
reformatting the content of the web pages into a text-to-speech format.

15. The method of claim 1, wherein the step (c) comprises:
reformatting the content of the web pages into a format compatible with Braille-based peripheral devices.

16. The method of claim 1, wherein the step (c) comprises:
reformatting the content of the web pages into a large-print format.

17. The method of claim 1, wherein the step (c) comprises:
reformatting color properties of the content of the web pages.

18. The method of claim 1, wherein the step (c) comprises:
modifying the content to address the nature of a user's disabilities.

19. The method of claim 1, wherein the user's communication device is a general-purpose computer, a mobile computer, a hand-held computer, a browser-equipped telephone, or a specialized device intended for use by a person with hearing, speech, mobility, or vision-related disabilities.

20. The method of claim 19, wherein the user's communication device is configurable to provide the server with said user-specific information.

21. The method of claim 2, wherein the step (d) comprises:
providing at least one of a list of sources of upgrades for drivers for user's peripheral devices, a list of user/server compatible peripheral devices, a list of user/server compatible software/hardware upgrades for the user's communication device.

22. A communication network, comprising:
a plurality of gateway nodes; and
at least one document server provided with assistive software adapted for converting the content of requested information resources in a plurality of formats compatible with a user communication device and/or with the needs of users with disabilities.

23. The network of claim 22, wherein said network is the Internet.

24. The network of claim 22, wherein the assistive software is stored in a dedicated or shared storage device of the document server.

25. The network of claim 22, wherein said storage device further contains a version of the content in a format compatible with the assistive software.

26. The network of claim 22, wherein the assistive software converts the content in formats compatible with peripheral devices assisting the users with disabilities.

27. The network of claim 26, wherein the peripheral devices are selected from the group consisting of a refreshable Braille display, a text-to-speech converter, a Braille printer, and a hearing aid device.

28. The network of claim 22, wherein the gateway nodes are accessible by users of communications devices for persons with disabilities.

29. The network of claim 28, wherein the communications devices for users with disabilities include computer terminals, mobile computers, hand-held computers, and phones for deaf and blind users.

30. A method for selectively transforming requested Internet resources to a format compatible with a user's disabilities, comprising:
(a) providing a document web server accessible by the user's communication device and having assistive software adapted for converting the content of web pages in a plurality of formats;
(b) obtaining user-specific information about formats compatible with the user's communication device and the user's disabilities;
(c) providing the requested Internet resources to the user's device in a format compatible with the user's disabilities if it is determined that the user's device does not have the capability of converting the requested Internet resources into a format compatible with the user's disabilities; and
(d) providing the requested Internet resources to the user's device in a format that is not compatible with the user's disabilities if it is determined that the user's device has the capability of converting the requested Internet resources in a format compatible with the user's disabilities.
